(19) United States
(12) Patent Application Publication
(10) Pub. No.: US 2012/0175870 A1
(43) Pub. Date: Jul. 12, 2012

(54) FLUSH VALVE PIPE STABILIZER

(76) Inventors: Paul J. RYAN, Lee's Summit, MO (US); Audie Murphy, Independence, MO (US); Warren G. Zettlemoyer, Raymore, MO (US)

(21) Appl. No.: 13/346,372

(22) Filed: Jan. 9, 2012

Related U.S. Application Data
(60) Provisional application No. 61/431,532, filed on Jan. 11, 2011.

(51) Int. Cl. F16L 55/00; B23P 17/00

(52) U.S. Cl. 285/114; 29/402.14

(57) ABSTRACT

A bracket assembly for stabilizing the connection between a pair of joined pipe segments includes a bracket element attached to each pipe segment, and a yoke element connecting the brackets and reinforcing the connection between the pipe segments. The pipe segments may be in a linear arrangement or may have an angular arrangement. The bracket may be a collar, a split ring, or a pair of joined arcuate pieces. The yoke element may be straight or curved.

### CROSS-REFERENCE TO RELATED APPLICATIONS

This application claims the benefit of U.S. Provisional Patent Application No. 61/431,532, filed Jan. 11, 2011, which is incorporated herein by reference.

### BACKGROUND OF THE INVENTION

This present disclosed technology relates to pipe fittings and connections. More particularly, this technology relates to the joining of plumbing pipes requiring a stable connection to withstand high pressures of flowing fluid to minimize separation of the pipe segments.

Plumbing pipes carrying fluid under pressure are subject to forces that can cause joined pipes to separate at their point of connection. This can be a problem in particular for pipes that are joined to each other in a 90 degree configuration. In such cases, the flow of fluid, such as water, through the pipes must change direction abruptly and in so doing exerts forces on the inner walls of the pipes that can cause separation of the pipes at their connection point. While standard connection devices, such as compression nuts, are generally adequate to hold pipes together under normal flow pressures, sudden pressure surges can create forces that surpass the ability of the existing connection device to maintain the connection of the joined pipe sections. In those cases, the pipes can become separated resulting in fluid leakage.

Public buildings and institutional settings typically utilize plumbing systems incorporating toilets with flushometer valves. Flushometer valves effect flushing through the release of a volume of highly pressurized water to the toilet bowl or urinal. Because of architectural requirements and space concerns, the pipes supplying the water to the toilets and urinals typically are configured with 90 degree bends. A typical flushometer valve installation utilizes vertical and horizontal discharge pipes joined together with a 90 degree slip joint elbow and compression nut. The high pressures associated with the water flow often cause this type of connection to fail and the pipe segments to separate resulting in potentially disastrous consequences such as flooding of the facility. This flooding can be very destructive to the facility and expensive to clean up.

### SUMMARY

The present disclosed subject matter includes an apparatus for reinforcing a connection between joined segments. The apparatus includes a bracket that engages each joined segment, and a yoke element that connects the brackets to reinforce the connection between the joined segments.

Another aspect of the disclosed subject matter includes an apparatus for engaging each joined segment where each bracket includes a pair of arcuate pieces joined by a fastener, and the yoke element has an aperture at each end for receiving the fastener of each bracket.

Another aspect of the disclosed subject matter includes a method for reinforcing a connection between joined segments by attaching the brackets to the joined segments and attaching a yoke to the brackets.

Another aspect of the disclosed subject matter includes a method for reinforcing a connection between joined segments by attaching a split collar bracket to each joined segment and attaching a yoke to the brackets.

These and other features, aspects and advantages of the present teachings will become better understood with reference to the following description, drawings, and appended claims.

### DRAWINGS

The drawings constitute a part of this specification and include exemplary embodiments of the disclosed subject matter and illustrate various objects and features thereof. The drawings are not intended to limit the scope of the present teachings in any way.

FIG. 1 is a perspective view of an embodiment of the bracket assembly as installed on a joined pipe arrangement.

FIG. 2 is a side elevation view of an embodiment of the bracket assembly.

FIG. 3 is a side elevation view of an embodiment of the bracket assembly taken generally along the line 3-3 in FIG. 2.

FIG. 4 is a side elevation view of an embodiment of the bracket assembly taken generally along the line 4-4 in FIG. 3.

### DETAILED DESCRIPTION

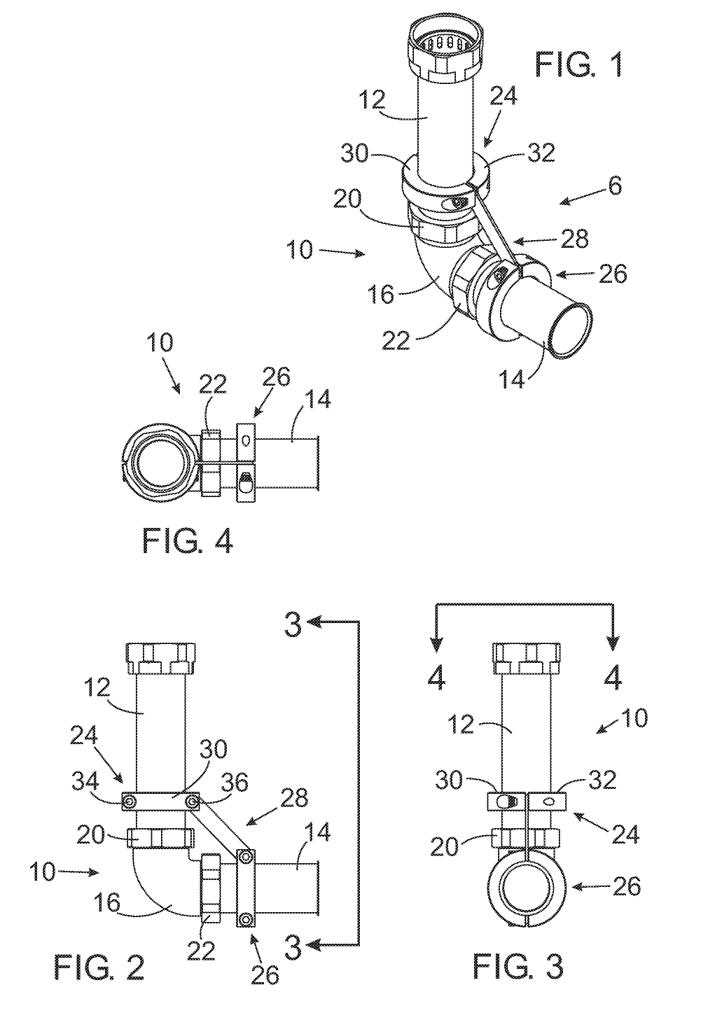

The bracket assembly 6 of the present disclosed subject matter is intended for use in stabilizing the connection between first and second members of a joined pair. As shown in FIG. 1, the joined pair may be a joined pipe arrangement 10 comprising a first, upper pipe segment 12, and a second, lower pipe segment 14 orientated substantially perpendicular to each other, with a terminal end of each connected to an angled member including a slip joint elbow 16, wherein the joined pipe arrangement 10 forms an angle having an inner radius of 90 degrees, and an outer radius. The joined pipe arrangement may be in a linear arrangement, may form an acute inner radius, or an obtuse inner radius. The two ends of the slip joint elbow 16 typically connect to an adjacent pipe segment by a compression nut 20, 22, thereby creating two connection points in the joined pipe arrangement 10 shown in FIGS. 1-4. The joined pipe arrangement 10 may be employed when providing plumbing to toilets and urinals (not shown). In a plumbing arrangement, the upper pipe segment 12 receives water from a supply source and the lower pipe segment 14 delivers the water to the toilet or urinal to which it is associated. In the institutional setting where a large multiple of toilet and urinal facilities are required, such as stadiums, prisons, or military barracks, water is usually supplied to each joined pipe arrangement 10 by a flushometer valve (not shown). A flushometer valve releases pressurized water directly into the toilet or urinal to evacuate the contents. As such, the flow of water through the joined pipe arrangement 10 is subject to intermittent high pressures, especially during flushing activity.

The force of the high pressure flow of water through the joined pipe arrangement 10 is especially felt at elbow 16, where the water abruptly changes direction. As a consequence, this pressure can place a substantial strain on the connection points around the compression nuts 20, 22. The force, if significant enough, can cause these connection points to fail resulting in immediate separation of the lower pipe segment 14 or upper pipe segment 12 from the elbow 16. In other scenarios, the compression nuts 20, 22 will loosen over time creating a separation between the slip joint elbow 16 and the upper and lower pipe segments 12, 14, or they may become completely dislodged. In either instance, water leakage will result.

The bracket assembly 6 of the present disclosed subject matter reinforces and stabilizes the connection between the first and second members of a joined pair of pipes, in particular the upper and lower pipe segments 12, 14 of the joined pipe arrangement 10, so that the connections between the first upper pipe segment 12, slip joint elbow 16, and second lower pipe segment 14 can withstand the high pressure flow of water through the joined pipe arrangement 10, and a leak at, or a separation of, the joined pipe arrangement 10 may be avoided. An embodiment of the bracket assembly 6 comprises a first bracket element 24 and a second bracket element 26 for engaging the first, upper pipe segment 12 and the second, lower pipe segment 14, respectively, and a yoke element 28 for connecting the first bracket element 24 and second bracket element 26. The bracket assembly 6 can be very effectively and efficiently employed as a retrofit to existing joined pipe arrangements 10, such as used in institutional settings with a large number of toilet and urinal facilities.

Each bracket element 24, 26 has a collar configuration comprising one or more pieces. The bracket elements 24, 26 have an internal circumference that corresponds to the exterior diameter or dimensions of the plumbing pipe used in the particular joined pipe arrangement. In an embodiment, each bracket element 24, 26 is comprised of a split collar arrangement. A split collar arrangement allows installation of each bracket element 24, 26 on an existing joined pipe arrangement 10 thereby avoiding a need to disconnect the joined pipe arrangement 10 or otherwise remove the slip joint elbow 16 to slide the bracket elements 24, 26 onto the pipes. In the embodiment shown in FIGS. 1-4, each bracket 24, 26 may comprise two separate first and second arcuate pieces 30, 32 that can be joined together around a pipe segment. Each arcuate piece 30, 32 may be provided with corresponding apertures to receive fasteners 34, 36 for securing the arcuate pieces 30, 32 together around the pipe segment. The fasteners 34, 36 may include threaded members, including screws or bolts, so that the bracket elements 24, 26 can be drawn tightly around the joined pipe arrangement 10 in firm engagement.

In an embodiment, each bracket element is a single ring with a sector removed forming a gap with opposing apertures for threadably receiving a fastener. The bracket element may be adapted to open from a closed configuration for lateral placement of the bracket around the pipe segment.

In an embodiment, each bracket element is a clamp.

The yoke element 28 engages each of the bracket elements 24, 26 to provide a stable connection between the joined pipe segments. The yoke element 28 is rigid to withstand the forces that may otherwise cause the joined pipe arrangement 10 to separate. An embodiment of the yoke element 28 comprises a straight element extending between a first end and a second end, with the respective ends having an aperture for receiving the fasteners that join the bracket elements 24, 26. The yoke element 28 may be generally located at the inner radius, and firmly holds the pipe segments 12, 14 together to prevent separation of the joined pipe arrangement 10. The yoke element 28 is of a sufficient length to span between the bracket elements 24, 26 when placed at their respective positions on the joined pipe arrangement 10. The bracket assembly 6 eliminates or substantially reduces any relative vertical or horizontal movement between the pipe segments 12, 14 that might occur during an episode of high pressure water flow.

In an embodiment, the yoke element may extend between the bracket elements 24, 26 at the outer radius whereby the yoke element comprises a curved element having apertures on each end for securing to the bracket elements 24, 26.

In an embodiment, the bracket elements 24, 26 are used with both a yoke element at the inner radius and a yoke element at the outer radius.

The stabilizing bracket assembly 6 of the present disclosed subject matter may also be installed at the time of original installation of the joined pipe arrangement 10. It may also be used to hold joined pipe segments that are in linear alignment or where the joined pipe segments lie in any angular orientation to each other.

The detailed description set-forth above is provided to aid those skilled in the art in practicing the present disclosed subject matter. However, the subject matter described and claimed herein is not to be limited in scope by the specific embodiments herein disclosed because these embodiments are intended as an illustration of several aspects of the technology. Any equivalent embodiments are intended to be within the scope of the disclosed subject matter. Indeed, various modifications of the technology in addition to those shown and described herein will become apparent to those skilled in the art from the foregoing description which do not depart from the spirit or scope of the disclosed technology. Such modifications are also intended to fall within the scope of the appended claims.

Having just described the disclosed subject matter, what is claimed as new and desired to be secured by Letters Patent is:

1. An apparatus for reinforcing a connection between a first and second member of a joined pair, comprising:
a first bracket element for engaging the first member;
a second bracket element for engaging the second member; and
a yoke element for connecting the first bracket element and the second bracket element in a fixed relation whereby the connection of the joined pair is reinforced by the engagement of the yoke element with the first and second bracket elements.

2. The apparatus of claim 1, wherein each of the first and second bracket elements comprise a collar configuration.

3. The apparatus of claim 1, wherein each of the first and second bracket elements comprise a split ring configuration.

4. The apparatus of claim 1, wherein each of the first and second bracket elements comprise:
a first arcuate piece; and
a second arcuate piece joined to the first arcuate piece.

5. The apparatus of claim 1, wherein each of the first and second bracket elements comprise a clamp.

6. The apparatus of claim 1, wherein the yoke element comprises a straight element.

7. The apparatus of claim 6, wherein the straight element is a bar.

8. The apparatus of claim 6, further comprising a second yoke element, the second yoke element comprising a curved element.

9. The apparatus of claim 8, wherein the curved element is a bar.

10. The apparatus of claim 1, wherein the first bracket element is orientated substantially perpendicular to the second bracket element when the bracket elements are mounted to the first and second joined pair.

11. An apparatus for reinforcing a connection between a first and second pipe member of a joined pair, comprising:
a first bracket element for engaging the first pipe member, the first bracket element comprising:
a first arcuate piece; and
a second arcuate piece joined to the first arcuate piece by a fastener;
a second bracket element for engaging the second pipe member, the second bracket element comprising:
a first arcuate piece; and
a second arcuate piece joined to the first arcuate piece by a fastener;
a yoke element having a first end and a second end, the first and second ends further including an aperture wherein the first end aperture receives the fastener of the first bracket element, and the second end aperture receives the fastener of the second bracket element.

12. The apparatus of claim 11, wherein the yoke element comprises a straight element.

13. The apparatus of claim 12, wherein the straight element is a bar.

14. The apparatus of claim 12, further comprising a second yoke element, the second yoke element comprising a curved element.

15. The apparatus of claim 14, wherein the curved element is a bar.

16. The apparatus of claim 11, wherein the first bracket element is orientated substantially perpendicular to the second bracket element when the bracket elements are mounted to the first and second joined pair.

17. A method for reinforcing a connection between a first pipe member and a second pipe member of a joined pair, comprising:
attaching a first bracket element adjacent a terminal end of the first pipe member;
attaching a second bracket element adjacent a terminal end of the second pipe member;
attaching a straight yoke element to, and extending between, the first bracket element and the second bracket element, whereby the first and second bracket elements, and the yoke element cooperate to reinforce the connection between the first pipe member and the second pipe member.

18. The method of claim 17, further comprising:
attaching an angled member between the first pipe member and second pipe member; and
orientating the first pipe member at an angle to the second pipe member, whereby the first and second bracket elements and the yoke element cooperate to hold the first pipe member and second pipe member in the angled orientation, and reinforce the connections between the first pipe member, second pipe member, and angled member.

19. The method of claim 18, further comprising orientating the first pipe member perpendicular to the second pipe member, whereby the first and second bracket elements and the yoke element cooperate to hold the first pipe member and second pipe member in a 90 degree orientation, and reinforce the connections between the first pipe member, second pipe member, and angled member.

20. The method of claim 18, further comprising orientating the first pipe member at an acute angle to the second pipe member, whereby the first and second bracket elements and the yoke element cooperate to hold the first pipe member and second pipe member in the acute angled orientation, and reinforce the connections between the first pipe member, second pipe member, and angled member.

21. The method of claim 18, further comprising orientating the first pipe member at an obtuse angle to the second pipe member, whereby the first and second bracket elements and the yoke element cooperate to hold the first pipe member and second pipe member in the obtuse angled orientation, and reinforce the connections between the first pipe member, second pipe member, and angled member.

22. The method of claim 17, further comprising attaching a curved yoke element to, and extending between, the first bracket element and the second bracket element, whereby the first and second bracket elements, and the curved yoke element cooperate to reinforce the connection between the first pipe member and the second pipe member.

23. A method for reinforcing a connection between a first pipe member and a second pipe member of a joined pair, comprising:
attaching a first split collar clamp adjacent a terminal end of the first pipe member;
attaching a second split collar clamp adjacent a terminal end of the second pipe member;
attaching a yoke element to, and extending between, the first split collar clamp and the second split collar clamp, whereby the first and second split collar clamps, and the yoke element cooperate to reinforce the connection between the first pipe member and the second pipe member.
